(19) United States
(12) Patent Application Publication
(10) Pub. No.: US 2006/0001986 A1
(43) Pub. Date: Jan. 5, 2006

(54) Optical device

(76) Inventor: Takashi Itohiya, Saitama-shi (JP)

Correspondence Address: JACOBSON HOLMAN PLLC, 400 SEVENTH STREET N.W., SUITE 600, WASHINGTON, DC, 20004, US

(21) Appl. No.: 11/168,878

(22) Filed: Jun. 29, 2005

(30) Foreign Application Priority Data
Jun. 30, 2004 (JP) 2004-194000
Jun. 3, 2005 (JP) 2005-164091

(51) Int. Cl. G02B 7/02

(52) U.S. Cl. 359/819

(57) ABSTRACT

An optical device according to the present invention is easy to finely adjust at least part of the lens optics and stable to secure the fine adjustment without decentering the part of the lens optics. The optical device includes a fixed lens barrel and a lens frame capable of sliding linearly along the optical axis and circumferentially about the same in relation with the fixed lens barrel where the fixed lens barrel and the slidable lens frame are mated with each other in cam engagement, and the fixed lens barrel is rotated relative to the slidable lens frame so as to move the slidable lens frame. While a fixing screw is fitted in the slidable lens frame, two elements engaged with the fixing screw pinch the fixed lens barrel between them so that the fixing screw is secured to the fixed lens barrel and that the slidable lens frame is secured to the fixed lens barrel.

### FIELD OF THE INVENTION

The present invention relates to an optical device, such as a rear projection picture device like a rear projection TV set and a rear projector, and a high resolution monitor camera, which project light beam from behind of the screen to display an enlarged image thereon, and more particularly, it relates to an optical device that requires to retain highly accurate optical adjustability and enhanced optical stability of lens optics.

### BACKGROUND ART

In the context of the rear projector, there are provided a lower cabinet that houses an image formation unit, and a primary body of screen, and an image displayed on a liquid crystal image display device in the image formation unit is projected from behind the screen to produce an enlarged image (i.e., a magnified picture) thereon (see Patent Document 1 listed below).

The prior art rear projection picture device consists of upper and lower cabinets and is structured to project light beam from behind the screen and display an enlarged image (i.e., a magnified picture) thereon (see Patent Document 2 listed below).

The prior art rear projection TV set includes primary components housed in upper and lower cabinets such as a screen and mirrors in the upper cabinet and imaging equipment, driving and control circuits, and an optical unit including a projection lens in the lower cabinet (see Patent Document 3).

In the lens optics for the devices as disclosed in Patent Documents 1 to 3, the eventual refining adjustment of a lens arrangement is, in general, carried out by providing a variety of separating collars in advance and then selecting appropriate ones for each of the devices. In another example of the refining adjustment of the lens arrangement, a decentering pin mechanism is provided so that lens holding frames are moved along the optical axis to adjust lens positions.

Regarding to the optics of the monitoring camera, on the other hand, supposed is an arrangement of a power varying lens and a focusing lens moved independent of each other, and with such a simple structure, an angle of view as desired in monitoring by the user can be attained (see Patent Document 4).

For example, as shown in FIG. 8, a variable lens 213 is placed behind an objective lens 220, being movable along the optical axis 226 of the objective lens 220. In addition, a power varying lens shift means 214 is located, having a power varying ring 234 used to move the power varying lens 213 along the optical axis 226. A focusing lens 215 is placed behind the power varying lens 213, being movable along the optical axis 226. Furthermore, a focusing lens shift means 216 is located, having a focusing ring 217 used to move the focusing lens 215 along the optical axis 226.

In this way, the angle of view in monitoring is adjusted by using the variable lens shift means 214 to move the power varying lens 213 along the optical axis 226 while light flux from the object is focused in a picture plane 250 by using the focusing lens shift means 216 to move the focusing lens 215 along the optical axis 226.

The power varying ring 234 has a power-varying/fixing threaded stud 234 screwed therein. Screwing the power-varying/fixing threaded stud down allows for its tip to come in contact with a lens barrel 218. In this manner, a power varying ring 234 is fixed to the lens barrel 218 to secure the power varying condition, namely, the angle of view in monitoring. The power-varying/fixing threaded stud 236 can also serve as a grip in moving the power varying ring 234 along the optical axis 226.

The focusing ring 217 is also provided with a focusing/fixing threaded stud (not shown). Screwing the focusing/fixing threaded stud down permits its tip to come in contact with the lens barrel 218. In this manner, the focusing ring 217 is fixed to the lens barrel 218 to secure the focusing.

### LIST OF CITATIONS TO THE PRIOR ART EXAMPLES

Patent Document 1: Japanese Preliminary Publication No. 2003-274314 (FIG. 1 to FIG. 7)

Patent Document 2: Japanese Preliminary Publication No. H09-98359 (FIG. 1 to FIG. 3)

Patent Document 3: Japanese Preliminary Publication No. H09-98357 (FIG. 1 to FIG. 6)

Patent Document 4: Japanese Preliminary Publication No. H07-113941 (Paragraph Nos. 0006 and 0007, Page 1, and FIG. 1)

In the rear projection TV set disclosed in the cited Patent Documents 1 to 3, a thinned housing accommodates all the components to resultantly provide an extremely short overall distance or a distance from the image display device and a projection magnification as high as 40 to 100 times, and this makes it necessary to highly accurately regulate the focusing and adjust the projection lens.

In such a configuration, even if the desired separating collar is selected from the separating collars as mentioned above and incorporated in the device, the number of the separating collars must be considerably large to resultantly cause a significant increase in the manufacturing cost, and accordingly the number of processes required to select and incorporate the desired ones is to be inadvertently large.

The mechanism using the decentering pin to adjust the positioning of the lens holding frame along the optical axis, as mentioned above, requires a small clearance in an engagement portion of the fixed lens barrel and the lens holding frame. The presence of the clearance is prone to decenter the lens due to a rotation of the decentering pin.

In the monitoring camera disclosed in Patent Document 4, a camera body housing an imaging lens must be attached on the ceiling or the similar high position hard to access and left there for a long time without physical handling, and still have to attain a highly clear imaging ability.

Allowing for the above, the lens system of the above-mentioned optical device, especially the imaging lens, needs a fine adjustment of the positional arrangement of the component lenses, and the adjusted lenses must keep unchanged over time for a long time without being decentered.

The power varying ring 234 for the monitoring camera described in Patent Document 4 has the power-varying/fixing threaded stud securely screwed down. Screwing the power-varying/fixing threaded stud 236 down in the power varying ring 234 causes its tip to come in contact with the lens barrel 218. In this way, the power varying ring 234 is fixed to the lens barrel 218. Thus, the power varying ring 234, which is to be secured to the lens barrel 218, is apt to transform the lens barrel 218 as the power-varying/fixing threaded stud 236 or is apt to be pressed in a direction as the threaded stud 236 advances to resultantly move perpendicular to the optical axis. As a consequence, the objective lens 220 and the power varying lens 213 held by the lens barrel 218 are prone to be decentered.

The similar proneness is unavoidable in screwing the focusing threaded stud (not shown) down in the focusing ring 217 to secure the focusing condition

The present invention is made to overcome the aforementioned disadvantages of the prior art optical devices, and accordingly, it is an object of the present invention to provide an optical device which is easy to finely adjust at least part of the lens optics along in position along the optical axis and stable to secure the fine adjustment for a long time without decentering the part of the lens optics.

It is another object of the present invention to provide an optical device which need not provide a variety of separating collars in advance and not require so much of the manufacturing cost for that purpose, and which need not require so large a number of processes for selecting and incorporating desired ones from various components.

### SUMMARY OF THE INVENTION

In a first optical device according to the present invention that includes a fixed lens barrel and a lens frame capable of sliding linearly along the optical axis and circumferentially about the same in relation with the fixed lens barrel, the fixed lens barrel and the slidable lens frame being mated with each other in cam engagement, and the fixed lens barrel being rotated relative to the slidable lens frame so as to move the slidable lens frame,
while a fixing screw is fitted in the slidable lens frame, two elements engaged with the fixing screw pinch the fixed lens barrel between them so that the fixing screw is secured to the fixed lens barrel and that the slidable lens frame is secured to the fixed lens barrel.

In a second optical device according to the present invention that includes a fixed lens barrel and a lens frame capable of sliding linearly along the optical axis and circumferentially about the same in relation with the fixed lens barrel, the fixed lens barrel and the slidable lens frame being mated with each other in cam engagement, and the fixed lens barrel being rotated relative to the slidable lens frame so as to move the slidable lens frame,
while a fixing screw is fitted in the fixed lens barrel, two elements engaged with the fixing screw pinch the slidable lens frame between them so that the fixing screw is secured to the slidable lens frame and that the slidable lens frame is secured to the fixed lens barrel.

The first and second embodiments of the optical device according to the present invention are further characterized as follows:

The cam engagement of the fixed lens barrel with the slidable lens frame is implemented by a cam groove formed in the slidable lens frame and a cam pin provided in the fixed lens barrel.

The cam engagement of the fixed lens barrel with the slidable lens frame is implemented by a cam groove formed in the fixed lens barrel and a cam pin provided in the slidable lens frame.

In the first embodiment of the optical device according to the present invention, at least one of the two elements, which are engaged with the fixing screw and pinch the fixed lens barrel between them, has its contact surface to the fixed lens barrel shaped in circumferentially curved surface identical in curvature with a contact surface of the fixed lens barrel to the pinching element.

In the second embodiment of the optical device according to the present invention, at least one of the two elements, which are engaged with the fixing screw and pinch the slidable lens frame between them, has its contact surface to the slidable lens frame shaped in circumferentially curved surface identical in curvature with a contact surface of the slidable lens frame to the pinching element.

An optical device according to the present invention is easy to finely adjust at least part of the lens optics and stable to secure the fine adjustment without decentering the part of the lens optics.

Another optical device according to the present invention need not provide a variety of separating collars in advance and not require so much of the manufacturing cost for that purpose, and which need not require so large a number of processes for selecting and incorporating desired ones from various components.

Still another optical device according to the present invention need not a decentering pin and a small clearance in an engagement portion between the fixed lens barrel and the lens holding frame, and is not prone to decenter the lenses due to the presence of the clearance.

### BRIEF DESCRIPTION OF THE DRAWINGS

FIG. 1 is a perspective view showing an adaptor flange and a fixed lens barrel of a first embodiment of an optical device according to the present invention;

FIG. 2 is a sectional view showing optics and a lens barrel of the first embodiment of the optical device according to the present invention;

FIG. 3 is a side view showing the optics and the lens barrel of the first embodiment of the optical device according to the present invention;

FIG. 4 is a diagram illustrating a stud and a joint screw of the first embodiment of the optical device according to the present invention;

FIG. 5 is a side view of an adaptor flange and a fixed lens barrel along with a slidable lens barrel of a second embodiment of the optical device according to the present invention;

FIG. 6 is a plan view showing a stud of the second embodiment of the optical device according to the present invention;

FIG. 7 is a diagram illustrating the stud and a joint screw of the second embodiment of the optical device according to the present invention; and

FIG. 8 is a sectional view showing an optics and a lens barrel of the prior art optical device.

### BEST MODE OF THE INVENTION

Preferred embodiments of the present invention will now be described.

The preferred embodiments will be detailed in conjunction with the accompanying drawings of the embodiments of the present invention.

### EMBODIMENT 1

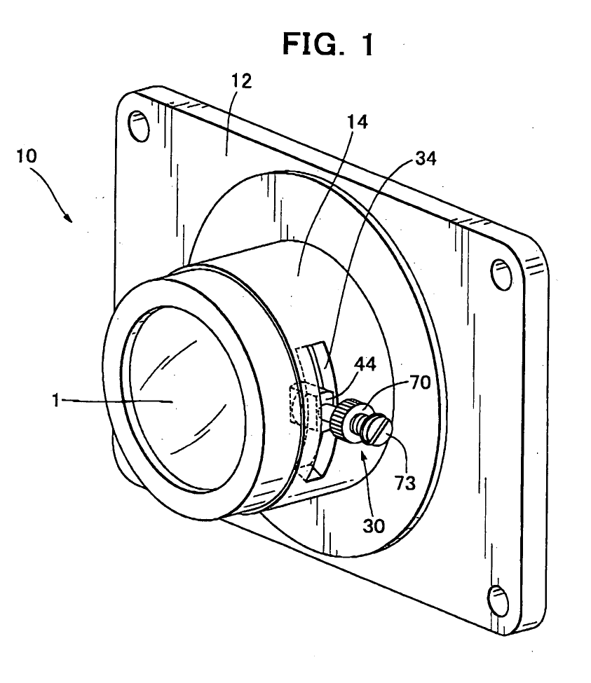

An optical device 10 in a first preferred embodiment is projection lens optics dedicated to a rear projection picture device such as a rear projection TV set, a rear projector and the like. The optical device 10 has, as shown in FIG. 1, an adapter flange 12 and a fixed lens barrel 14 integrally molded of synthetic resin.

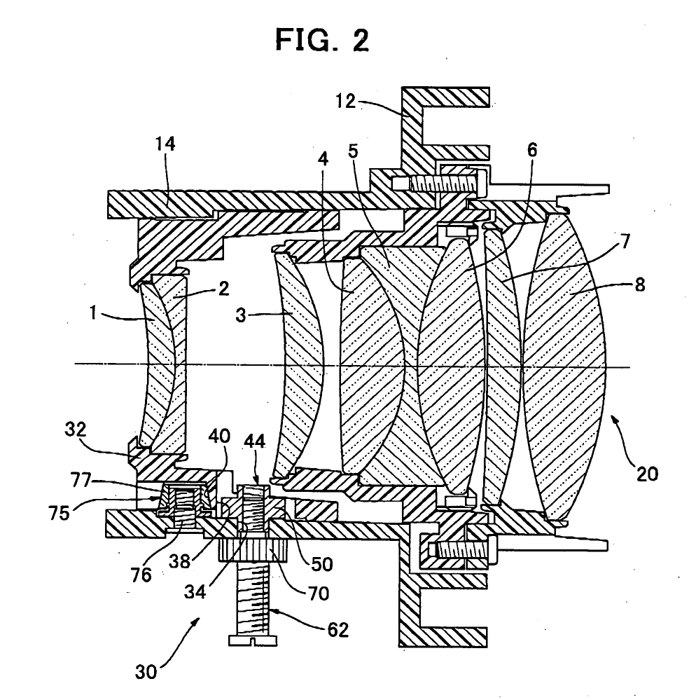

As can be seen in FIG. 2, the fixed lens barrel 14 houses an imaging lens 20 consisting of lenses 1 to 8. The lenses 3 to 8 are fixedly held in some well known manner. The lenses 1 and 2 are the ones which greatly affect an imaging performance and a focal length and are held by a lens position adjusting mechanism 30 so as to be able to adjust the lenses in position along the optical axis.

The lens position adjustment mechanism 30 has, as depicted in FIG. 2, a slidable lens frame 32 inside a distal end of the fixed lens barrel 14, namely, inside an end opposed to the adapter flange 12.

As can be seen in FIGS. 1 and 2, the fixed lens barrel 14 is provided with a circular groove 34 extending in a plane orthogonal to the optical axis.

The fixed lens barrel 14 is, as shown in FIG. 2, further provided with three cam studs 75 extending inward and fitted in three of cam grooves 40 in the slidable lens frame 32 described later. Each of the cam studs 75 is comprised of a metal pin 76 with a shock absorbing ring 77 made of material of reduced frictional resistance, and the shock absorbing ring 77 is fitted in the corresponding one of the cam grooves 40.

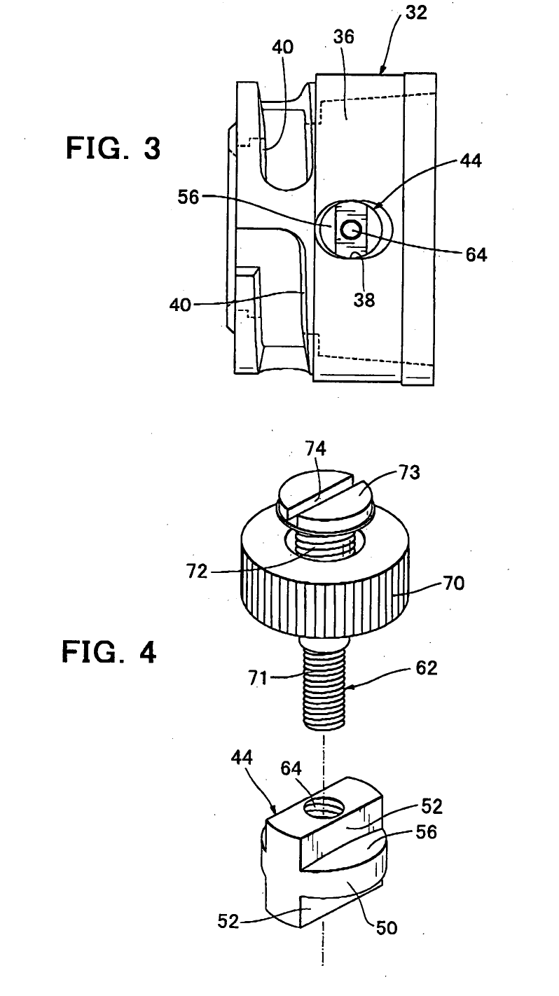

As can be seen in FIG. 3, the slidable lens frame 32 has a linear groove 38 extending along the optical axis in its circumferential surface 36 that is frictionally fitted on an inner surface of the fixed lens barrel 14. The distal end of the circumferential surface 36 is provided with three of the cam grooves 40 that are used to adjust the lenses 1 and 2 in positions along the optical axis. Three of the cam studs 75 are fitted in their respective corresponding ones of the three cam grooves 40.

A slidable stud 44 as shown in FIG. 4 is fitted in the linear groove 38 in the slidable lens frame 32. The slidable stud 44 consists of a pillar member 50 and flat projection members 52 sidably fitted in the circumferential groove 34 in the fixed lens barrel 14. The pillar member 50 frictionally slides, being in point-contact with the linear groove 38, and therefore, smoothness of the sliding movement is not lost. The flat projection members 52 are shaped symmetrical about the discwise extension of the pillar member 50, and this shape is devised so as not to need a directional control during the assembling. A top 56 of the pillar member 50 is faced against the inner circumferential surface of the fixed lens barrel 14 once the optical device is assembled.

Throughout the pillar member 50 and the flat projection members 52, a threaded hole 64 is formed, having a longitudinal axis equivalent to that of the pillar member 50, an adjusting/fixing screw 62 is mated with the threaded hole 64. The adjusting/fixing screw 62 is, as shown in FIG. 4, comprised of a screw 71 of a smaller diameter fitted in the threaded hole 64, a screw 72 of a larger diameter fitted in a fastening nut 70, and a head 73 of greater in diameter than both the screws so as not let the fastening nut 70 slip off. In the upper major surface of the head 73, a slit 74 is formed for a user to use a screw driver to turn the screw 71 of a smaller diameter down in the threaded hole 64.

The first embodiment of the optical device functions as follows.

First, as depicted in FIGS. 1 and 2, the optical devices are assembled so that each of the three cam studs 75 is fitted in the corresponding one of the cam grooves 40 in the slidable lens frame 32 to serve as a cam together. With the pillar member 50 being slidably fitted in the linear groove 38, the adjusting/fixing screw 62 is screwed down in the threaded hole 64 formed through the slidable stud 44. Keeping engagements of these components with each other, the adjusting/fixing screw 62 is rotated circumferentially about the optical axis to let the cam groove 40 guide the cam stud 75; that is, as the adjusting/fixing screw 62 is rotated circumferentially about the optical axis, the pillar member 50 slides in the linear groove 38. In this way, the lenses 1 and 2 held by the slidable lens frame 32 are moved along the optical axis and adjusted in positions.

After completing the adjustment of the lenses in positions, the fastening nut 70 is mated with the screw 72 of a larger diameter. At this time, the engagement of the flat projection members 51 with the circumferential groove 34 prevents the adjusting/fixing screw 62 from rotating. Screwing the fastening nut 70 down on the screw 72 results in the fixed lens barrel 14 being pinched between the pillar member 50 of the slidable stud 44 and the fastening nut 70, and thus, the slidable lens frame 32 and therefore the lenses 1 and 2 are secured to the fixed lens barrel.

### EMBODIMENT 2

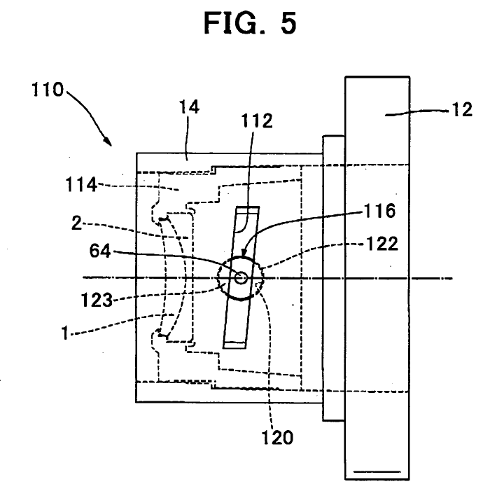

A second preferred embodiment of the present invention, is an optical device 110, as depicted in FIG. 5 where like reverence numerals denote the similar components to those of the optical device 10 of the first embodiment, and the descriptions of the components are omitted. The optical device 110 of the second preferred embodiment of the present invention has a slidable lens barrel 114 with a cam groove 112 in an inclined surface relative to the plane orthogonal to the optical axis. The slidable lens barrel 114, which frictionally slides on an inner surface of the fixed lens barrel 14, holds the lenses 1 and 2.

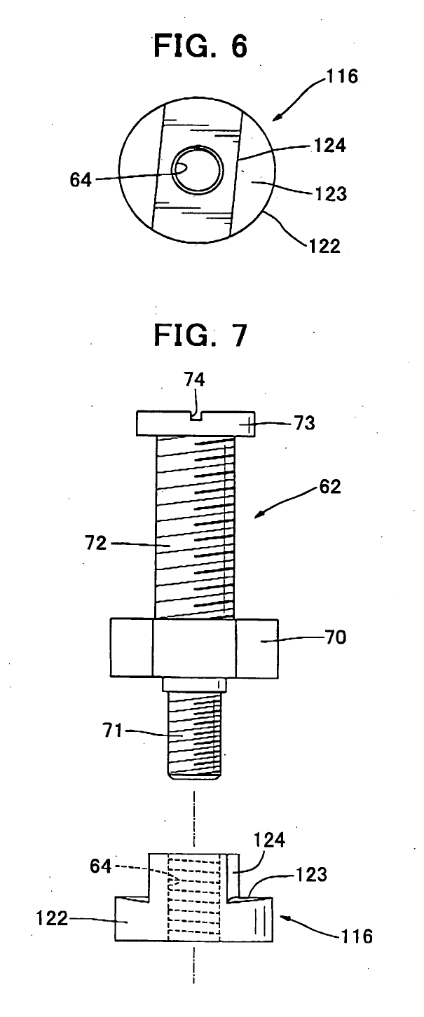

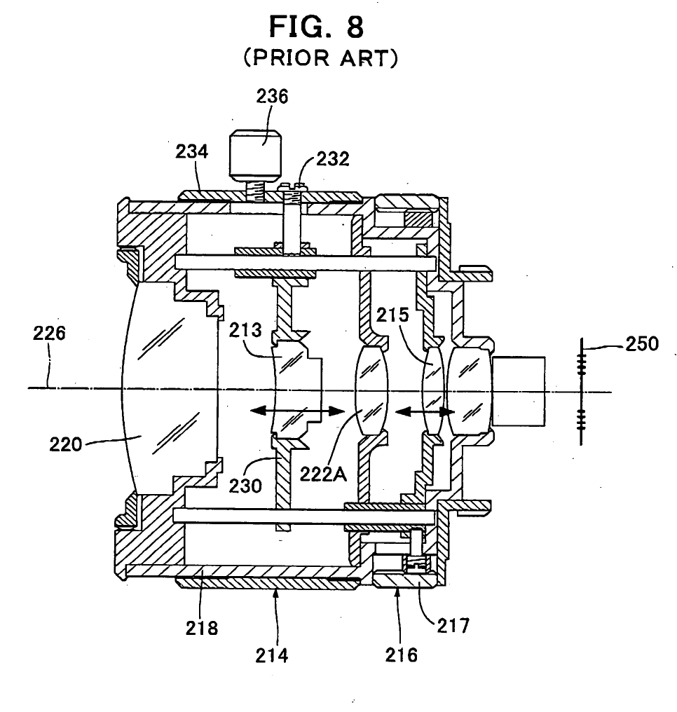

The slidable lens barrel 114 is provided with a circular hole 120. A positioning stud 116 is fitted in the circular hole 120 and frictionally slid therein in the circumferential directions about the optical axis. The positioning stud 116 is, as shown in FIGS. 6 and 7, comprised of a pillar member 122 slidably fitted in the circular hole 120 and flat projection members 124. The flat projection members 124 are fitted in the cam groove 112 to serve as a cam follower. A top 123 of the pillar member 122 is faced against the inner circumferential surface of the fixed lens barrel 114 once the optical device is assembled.

The second embodiment of the optical device functions as follows.

First, the optical devices are assembled so that the positioning stud 116 is mated with the circular hole 120 and the flat projection members 124 are frictionally fitted in the cam groove 112. Additionally, an adjusting/fixing screw 62 is screwed down in a threaded hole 64. Keeping engagements of these components with each other, the adjusting/fixing screw 62 is rotated circumferentially about the optical axis to let the cam groove 112 guide the positioning stud 116 along the optical axis. In this way, the lenses 1 and 2 held by the slidable lens frame 32 are moved along the optical axis and adjusted in positions.

After completing the adjustment of the lenses in positions, the fastening nut 70 is mated with the screw 72 of a larger diameter. At this time, the engagement of the flat projection members 124 with the cam groove 112 prevents the adjusting/fixing screw 62 from rotating. Screwing the fastening nut 70 down on the screw 72 results in the fixed lens barrel 14 being pinched between the pillar member 122 of the positioning stud 116 and the fastening nut 70, and thus, the slidable lens frame 114 and therefore the lenses 1 and 2 are secured to the fixed lens barrel.

Although the preferred embodiments of the present invention have been described in the context of the projection lens optics for the rear projection picture device such as a rear projection TV set, a rear projector, and the like, the present invention can also be effectively implemented in a projection optics for optical devices such as a high resolution monitoring camera. Moreover, the present invention can further be advantageously implemented in any lens optics such as a relay optics, an illumination optics, and the like.

1. In an optical device that includes a fixed lens barrel and a lens frame capable of sliding linearly along the optical axis and circumferentially about the same in relation with the fixed lens barrel, the fixed lens barrel and the slidable lens frame being mated with each other in cam engagement, and the fixed lens barrel being rotated relative to the slidable lens frame so as to move the slidable lens frame,
while a fixing screw is fitted in the slidable lens frame, two elements engaged with the fixing screw pinch the fixed lens barrel between them so that the fixing screw is secured to the fixed lens barrel and that the slidable lens frame is secured to the fixed lens barrel.

2. In an optical device that includes a fixed lens barrel and a lens frame capable of sliding linearly along the optical axis and circumferentially about the same in relation with the fixed lens barrel, the fixed lens barrel and the slidable lens frame being mated with each other in cam engagement, and the fixed lens barrel being rotated relative to the slidable lens frame so as to move the slidable lens frame,
while a fixing screw is fitted in the fixed lens barrel, two elements engaged with the fixing screw pinch the slidable lens frame between them so that the fixing screw is secured to the slidable lens frame and that the slidable lens frame is secured to the fixed lens barrel.

3. An optical device according to claim 1, wherein the cam engagement of the fixed lens barrel with the slidable lens frame is implemented by a cam groove formed in the slidable lens frame and a cam pin provided in the fixed lens barrel.

4. An optical device according to claim 1, wherein the cam engagement of the fixed lens barrel with the slidable lens frame is implemented by a cam groove formed in the fixed lens barrel and a cam pin provided in the slidable lens frame.

5. An optical device according to claim 1, wherein at least one of the two elements, which are engaged with the fixing screw and pinch the fixed lens barrel between them, has its contact surface to the fixed lens barrel shaped in circumferentially curved surface identical in curvature with a contact surface of the fixed lens barrel to the pinching element.

6. An optical device according to claim 2, wherein at least one of the two elements, which are engaged with the fixing screw and pinch the slidable lens frame between them, has its contact surface to the slidable lens frame shaped in circumferentially curved surface identical in curvature with a contact surface of the slidable lens frame to the pinching element.
